(19) United States
(12) Patent Application Publication
(10) Pub. No.: US 2015/0052004 A1
(43) Pub. Date: Feb. 19, 2015

(54) SYSTEM FOR OPTIMIZING CLOTHING OUTFITS FOR A USER

(71) Applicant: Aisha TaTanisha Jones, San Diego, CA (US)

(72) Inventor: Aisha TaTanisha Jones, San Diego, CA (US)

(21) Appl. No.: 14/183,497

(22) Filed: Feb. 18, 2014

Related U.S. Application Data
(60) Provisional application No. 61/765,782, filed on Feb. 17, 2013.

(51) Int. Cl. G06Q 30/06; G09B 19/00

(52) U.S. Cl. CPC G06Q 30/0631; G09B 19/0023; G09B 19/0076
USPC 705/26.7; 434/395

(57) ABSTRACT

A system is disclosed for assisting a person in selecting clothing and accessory outfits for various situations. A plurality of card members display various reference characters having sample clothing outfit combinations and a plurality of accessory options are provided. A website extension is available to increase a user's access to updated fashion information regarding accessory option combinations as well as cost and source information from where to procure the options.

### CROSS-REFERENCE TO RELATED APPLICATION

This patent application claims the benefit of priority to U.S. Provisional Patent Application Ser. No. 61/765,782 entitled “Outfit Creation Card System” to Aisha TaTanisha Jones filed on Feb. 17, 2013, the contents of which are fully incorporated herein by reference in its entirety for all purposes to the extent not inconsistent with the present patent application (ATTY. DOCKET NO. AJ-001-Prov).

### BACKGROUND

1. Field

The present disclosure generally relates to personal fashion decisions, and more particularly, to a system for coordinating outfits.

2. Related Art

Clothing choices impact our daily lives in both personal and professional settings. Judgments are regularly based on how people appear in public. A man dressed in a suit commands more trust and authority than a man dressed in thread-bare, shoddy clothing.

A well-chosen outfit can project a particular image, impacting the outcome of various situations, such as for example job interviews, professional presentations, and romantic encounters. Dressing well for women is increased in complexity as that requires mixing and matching appropriate pieces of clothing, jewelry, purse, and shoes for those various situations.

Self-esteem is often tied to the way other people perceive us. When we are complimented on our clothing choices, we feel good. This boosts confidence and improves self-perception. A short person appears taller when they wear vertical stripes in their clothing. An overweight person appears slimmer in certain kinds of clothing options, such as darker colors.

What a person wears reflects a personality unique to that individual. Fashion preferences also have psychological implications as they divulge a part of the person. In many instances, a person balances cultural expectations and personal taste in choosing an outfit.

Making fashion choices to accentuate a particular body type or social situation can be vital to a successful experience, in either personal or professional situations. In some situations, a woman may wish to appear particularly alluring to a potential mate, but the same woman may wish to appear less alluring and more professional, depending on the circumstances. With all the choices available in the modern fashion world, it is challenging to properly select a combination of clothing and accessories for specific occasions.

Putting together an appropriate outfit can be an intimidating task because of requirements, such as time, money, effort, and a knowledge of fashion to devote to aligning fashion trends with personal taste and budget constraints. While hiring a fashion consultant is an attractive alternative, such an endeavor is an expensive option and such a consultant will not always be available when a person needs to decide what outfit to put together for every occasion.

As described above it is a challenging but important task to select a proper clothing outfit for various occasions, for which the outcome can be important to a person, such as obtaining a job, or making the desired impact on a potential romantic partner. The present teachings solve these problems, as will now be described.

### SUMMARY

In one embodiment, a system for identifying a target outfit combination for a user is disclosed. The system for identifying a target outfit combination for a user generally comprises a plurality of card members, an illustrated reference character, a narrative element, a plurality of ingredients, and a plurality of options.

In one embodiment, a system for determining an outfit is disclosed. The system for determining an outfit generally comprises a roulette card, a plurality of columns, a plurality of different randomized numbers, a plurality of rows, and using a current day of a current month.

In one embodiment, a system for optimizing clothing outfits for a user is disclosed. The system comprises a plurality of card members having an authentication credential and a website extension.

### BRIEF DESCRIPTION OF THE DRAWINGS

Embodiments of the present disclosure will be more readily understood by reference to the following figures, in which like reference numbers and designations indicate like elements.

FIG. 1a illustrates a front side of a card system, according to one embodiment of the present teachings.

FIG. 1b illustrates a rear side of a card system, according to one embodiment of the present teachings.

FIG. 2a illustrates a side of a card system, according to another embodiment of the present teachings.

FIG. 2b illustrates a side of a card system, according to another embodiment of the present teachings.

FIG. 3 illustrates a card system and a website extension, according to another embodiment of the present teachings.

### DETAILED DESCRIPTION

### Overview

The present teachings disclose a system for optimizing choosing outfits for a user. The present disclosure overcomes a myriad of limitations due to, for example, lack of fashion sense, time and cost associated with dressing fashionably and appropriately for various situations. The present teachings describe how outfits for different occasions are recommended.

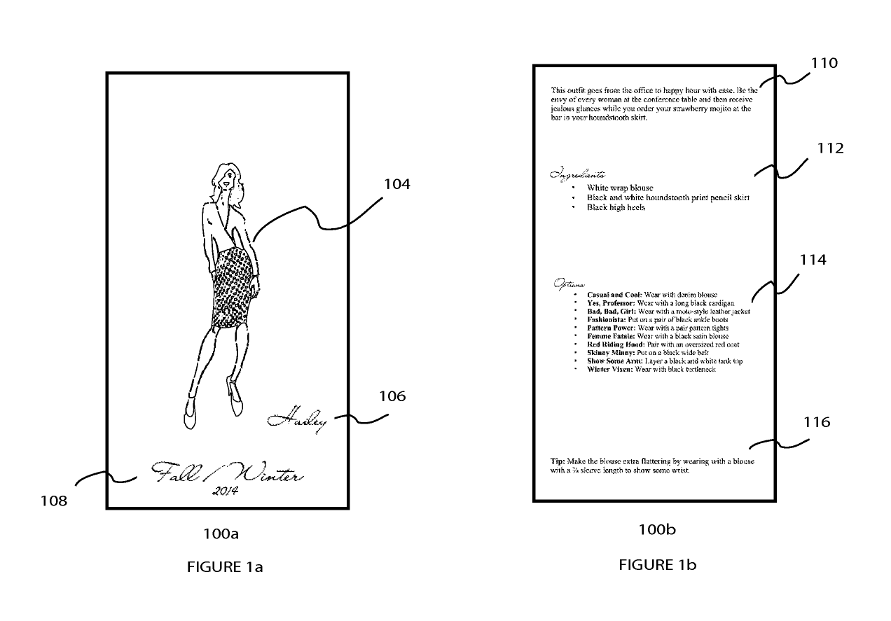

Referring now to FIG. 1a and FIG. 1b, one embodiment of a system for identifying a target outfit combination for a user is disclosed. The system generally comprises a plurality of card members 100, having a front card side 100a and a rear card side 100b, displaying an illustrated reference character 104, a narrative element 110, providing a plurality of ingredients 112, and providing a plurality of options 116. It will be appreciated that the present disclosure uses the reference numeral 100 to refer generally to the plurality of card members 100, having the front card side 100a and the rear card side 100b.

In one embodiment, the front card side 100a displays an illustrated reference character 104 with a name 106 for the illustrated reference character 104, and a collection section 108 defining a year and season for which the illustrated reference character's 104 outfit is fashionably relevant. In the illustrative exemplary embodiment shown in FIG. 1a, the illustrated reference character 104 is dressed in a particular assortment of clothing having a skirt and a blouse, which may be appropriate for a specific social setting, such as for example work or personal situations. It will be appreciated that other ones of the plurality of card members 100 comprise different reference characters having other variations of clothing options, such as for example pants and a blouse (not shown). A user may need to determine an outfit to wear to a job interview, to work, for a date, or to the opera, but not know how to put together a proper ensemble of clothing and accessories. Employing the present teachings, the user can readily search through different ones of the plurality of card members 100 to discover a particular outfit they may desire to wear.

In one embodiment, the rear card side 100b comprises a narrative element 110, a plurality of ingredients 112, a plurality of options 114, and a tip element 116. The narrative element 110 describes a setting that defines a social scope, such as for example a formal work setting when interaction with an employer is required or, alternatively a jovial atmosphere at a party. The plurality of ingredients 112 substantially corresponds to the plurality of clothing elements worn by the illustrated reference character 104. The plurality of options 114 is adapted to provide further variable attribute combinations for the plurality of clothing elements, such as, inter alia, an accessory such as a hand bag, jacket suggestion, necklace, fabric suggestion, pattern, color, seasonal variation such as a turtleneck, or color or style of high heel. The plurality of options 114 may further provide a list of situations matched with a suggested piece or pieces of clothing. For example, a “Casual and Cool” situation is matched with a suggested piece of clothing of a denim blouse. In one embodiment, the tip element 116 provides a more specific recommendation to further enhance the fashionability of the piece of clothing. An example under the tip element 116 is to wear a blouse with a ¾ sleeve length to show some wrist. Other examples of the tip element 116 include suggestions for different body types.

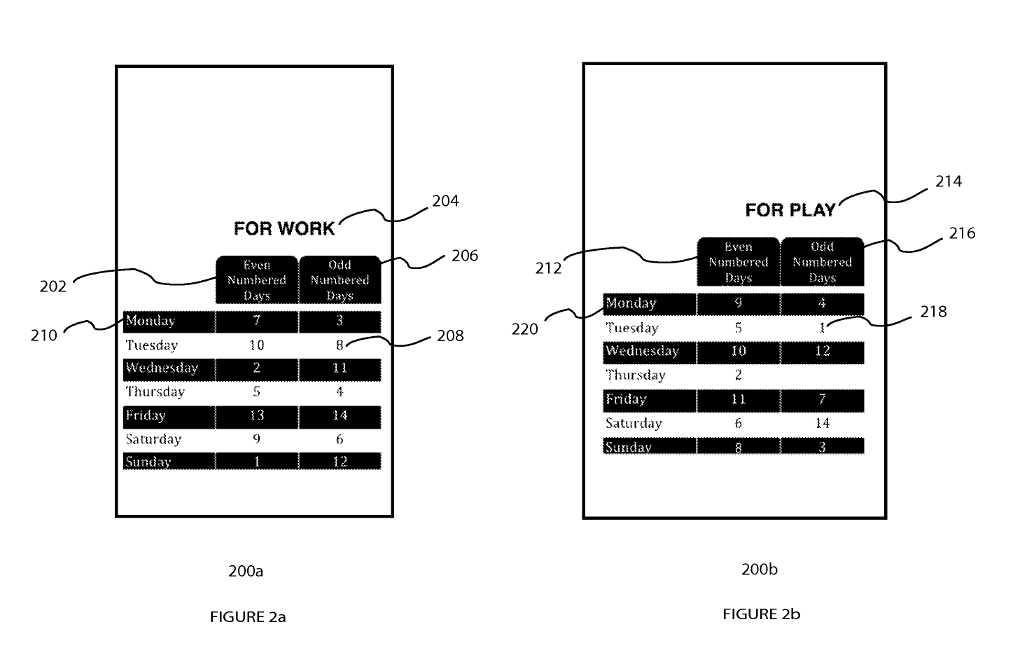

Referring now to FIG. 2a and FIG. 2b, a system for determining an outfit is disclosed. The system for determining an outfit comprises a step of providing a roulette card 200a or 200b, having at least one setting defining a social scope, such as for example “work” or “play”. In one embodiment, a roulette card 200a comprises a first column 210 having a plurality of cells, wherein each cell corresponds to a day of a week. A second column 202 has a plurality of cells, which are titled “Even Numbered Days”, which relate to even numbered days of a month. A third column 206 has a plurality of cells, which are titled “Odd Numbered Days” which relate to odd numbered days of the month. A plurality of randomized numbers 208 are disposed within the plurality of cells of both the second column 202 and the third column 206.

A user determines what calendar day of the month it is and employs the present teachings to determine an outfit to wear. In this exemplary embodiment, for work, if it is a Tuesday and an odd numbered day of the month, the randomized number 208 would be “8”, as illustrated in FIG. 2a. The specific randomized number corresponds to a particular reference character dressed in a certain manner as described above. Therefore, the user has randomly selected an appropriate outfit for the particular setting and social scope.

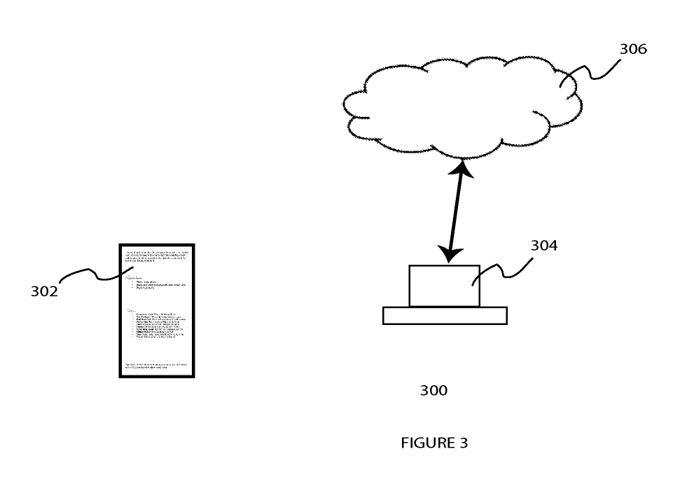

Referring now to FIG. 3, in one embodiment a system for optimizing clothing outfits 300 for a user is disclosed. The system for optimizing clothing outfits 300 generally comprises a plurality of card members 302 and a website extension comprising a computer network 306 and an electronic device 304 for accessing information on the computer network 306. The plurality of card members 302 is adapted to display a static content as described in the above embodiments (e.g., ingredients, options), but additionally comprises an authentication credential associated therewith. The authentication credential allows the user to authenticate themselves to the computer network 306 to access additional information through the electronic device 304. The additional information contained on the computer network 306 corresponds to updated material correlated to the static content on the plurality of card members 302. For example, the static content on one of the plurality of card members 302 may display a kind of high heel, jacket or necklace. The updated material accessible through the computer network 306 may contain current, seasonal variations for different styles or colors of high heels, jackets or necklaces. Additionally, the static content listed on the plurality of card members 302 are listed in text, whereas the website extension provides visual representations of the various combinations for the options. Also, the website extension uses hyperlinks, such that the user may simply click on a particular option combination to take the user to a website where an item may be purchased, or other combinations examined. In one embodiment, a flip-book element is adapted to allow the user to readily scroll through a plurality of combinations of options.

Those skilled in the art will appreciate that the present teachings may be practiced with other system configurations, including hand-held devices, multiprocessor systems, microprocessor-based or programmable consumer electronics, network PC's, minicomputers, mainframe computers, and the like. The present teachings may also be practiced in distributed computing environments where tasks are performed by remote processing devices that are linked through a communications network. In a distributed computing environment, program modules may be located in both local and remote memory storage devices.

The foregoing description illustrates exemplary implementations, and novel features, of aspects of the system for optimizing clothing outfits for a user. Alternative implementations are suggested, but it is impractical to list all alternative implementations of the present teachings. Therefore, the scope of the presented disclosure should be determined only by reference to the appended claims, and should not be limited by features illustrated in the foregoing description except insofar as such limitation is recited in an appended claim.

While the above description has pointed out novel features of the present disclosure as applied to various embodiments, the skilled person will understand that various omissions, substitutions, permutations, and changes in the form and details of the present teachings illustrated may be made without departing from the scope of the present teachings.

Each practical and novel combination of the elements and alternatives described hereinabove, and each practical combination of equivalents to such elements, is contemplated as an embodiment of the present teachings. Because many more element combinations are contemplated as embodiments of the present teachings than can reasonably be explicitly enumerated herein, the scope of the present teachings is properly defined by the appended claims rather than by the foregoing description. All variations coming within the meaning and range of equivalency of the various claim elements are embraced within the scope of the corresponding claim. Each claim set forth below is intended to encompass any apparatus or method that differs only insubstantially from the literal language of such claim, as long as such apparatus or method is not, in fact, an embodiment of the prior art. To this end, each described element in each claim should be construed as broadly as possible, and moreover should be understood to encompass any equivalent to such element insofar as possible without also encompassing the prior art. Furthermore, to the extent that the term “includes” is used in either the detailed description or the claims, such term is intended to be inclusive in a manner similar to the term “comprising.”

What is claimed is:

1. A system for identifying a target outfit combination for a user, comprising:
(a.) a plurality of card members, having a front card side and a rear card side;
(b.) displaying an illustrated reference character, disposed on the front card side, having a plurality of clothing elements;
(c.) a narrative element, disposed on the rear card side, describing at least one setting defining a social scope;
(d.) providing a plurality of ingredients, disposed on the rear card side, substantially corresponding to the plurality of clothing elements of the illustrated reference character, adapted to further specify attributes of the plurality of clothing elements, and;
(e.) providing a plurality of options, disposed on the rear card side, adapted to provide further variable attribute combinations for the plurality of clothing elements.

2. The system of claim 1, further comprising a tip element, adapted to provide further variable combinations based on body type.

3. The system of claim 1, further comprising a website extension, adapted to display the plurality of options provided on the rear card side visually on the website extension, wherein the plurality of card members further comprises an authentication credential for authenticating the user to the website extension to grant the user access to the website extension.

4. The system of claim 3, wherein the plurality of options comprises at least one hyperlink, wherein the at least one hyperlink corresponds to one of the plurality of options, whereby the at least one hyperlink connects the user to an updated source of information.

5. The system of claim 4, further comprising a flip-book element, adapted to scroll through a plurality of combinations of the plurality of options.

6. The system of claim 5, further comprising a shopping guide, adapted to provide cost and source information regarding the plurality of options, whereby the user may purchase an item listed in the plurality of options.

7. The system of claim 6, further comprising a style tutorial, adapted to provide the user with specific information related to a particular style.

8. The system of claim 7, further comprising a color analysis, adapted to provide the user with information regarding a personalized color scheme.

9. The system of claim 8, further comprising a body shape analysis, adapted to provide information relevant to optimizing the user options regarding particular body types.

10. A system for determining an outfit, comprising:
(a.) providing a roulette card, having at least one setting defining a social scope;
(b.) a first column, disposed on the roulette card, having a plurality of cells, corresponding to a plurality days of a week;
(c.) a second column, disposed on the roulette card, having a plurality of cells, corresponding to even number days of a calendar month;
(d.) a third column, disposed on the roulette card, having a plurality of cells, corresponding to odd number days of the calendar month;
(e.) a plurality of different randomized numbers, disposed within the plurality of cells of both the second column and the third column;
(f.) determining a current day of a current month;
(g.) selecting a row in the first column, corresponding to the current day of the current month;
(h.) determining whether the current day of the current month is even or odd;
(i.) selecting the second column if the current day is an even number, or selecting the third column if the current day is an odd number;
(j.) selecting a row corresponding to the current day from the first column;
(k.) selecting a column corresponding to the determined evenness or oddness of the current day;
(l.) identifying a one of the plurality of randomized numbers disposed in the selected row and column, and;
(m.) opening a reference character corresponding to the one of the plurality of randomized numbers identified.

12. The system of claim 11, wherein the at least one setting defining a social scope comprises a work setting.

13. The system of claim 11, wherein the at least one setting defining a social scope comprises a play setting.

14. A system for optimizing clothing outfits for a user, comprising:
(a.) a plurality of card members, adapted to display static content, wherein the plurality of card members has an authentication credential associated therewith, and;
(b.) a website extension, adapted to be accessed using the authentication credential from the plurality of card members, wherein the user can access the website extension to obtain a quantity of updated content relating to the plurality of card members static content.
